(19) United States
(12) Patent Application Publication
(10) Pub. No.: US 2018/0208067 A1
(43) Pub. Date: Jul. 26, 2018

(54) CHARGING DEVICE, CHARGING SYSTEM AND CHARGING METHOD FOR ELECTRIC VEHICLE

(71) Applicant: NIO CO., LTD., SHANGHAI (CN)

(72) Inventor: Hao ZHOU, Shanghai (CN)

(21) Appl. No.: 15/879,060

(22) Filed: Jan. 24, 2018

(30) Foreign Application Priority Data
Jan. 25, 2017 (CN) 201710056170.5

(51) Int. Cl. B60L 11/18

(52) U.S. Cl. CPC B60L 11/1818; B60L 2240/70; B60L 11/1851

(57) ABSTRACT

The invention provides a charging device, a charging system and a charging method for electric vehicle, and pertains to the technical field of electric vehicle charging control. The charging device of the invention is provided with a temperature sensor and a temperature signal feedback component. The charging system of the invention comprises the charging device, an on-board control unit and a remote communication control module disposed in the electric vehicle, and a mobile terminal, wherein the on-board control unit is configured to read the feedback signal sent from the temperature signal feedback component and send corresponding notification information of overheat in charging to the remote communication control module when the temperature is higher than or equal to a preset temperature value; the mobile terminal acquires the notification information of overheat in charging via the remote communication control module.

### CROSS-REFERENCE TO RELATED APPLICATIONS

This application claims the benefit of Chinese Patent Application No. 201710056170.5 filed Jan. 25, 2017, the entire disclosure of which is incorporated herein by reference.

### FIELD OF THE INVENTION

The invention pertains to the technical field of electric vehicle charging control, and relates to a charging device provided with a temperature sensor, a charging system in which a mobile terminal can acquire notification information of overheat in charging, as well as a charging method.

### BACKGROUND

Electric vehicle refers to a vehicle that is driven at least partially by electric power, and mainly comprises a battery-driven electric vehicle and a hybrid electric vehicle. The battery-driven electric vehicle means that the vehicle is driven by electric power only without using fossil fuels, and is typically called electric vehicle. The hybrid electric vehicle means that the vehicle is driven by electric power and fossil fuels. As a kind of new energy vehicles, the electric vehicle has become more and more accepted by users and is being more and more widely used.

The electric vehicle typically has a chargeable battery which is required to be charged frequently during use. A commonly used charging device is a charging gun, one end of which is connected to AC grid via a power plug, thereby providing DC charging continuously to the battery.

While many measures have been taken for the safety of charging when designing the charging device, currently, no special safety mechanism has been designed in view of the hidden safety hazard caused by the power plug of the charging device (e.g., the charging gun). For example, when the power plug of the charging device is connected to (in electrical contact with) a socket of AC grid, loosening of the fit between the power plug and the socket may be easy to occur due to a long time charging, or the electrical contact between the power plug and the socket may be weakened since the power cable near the power plug is in a bending state for a long time, thus easily resulting in overheat and posing hidden safety hazard.

### SUMMARY OF THE INVENTION

In order to address the above or other technical problems, the invention provides the following technical solutions.

According to an aspect of the invention, a charging device for electric vehicle is provided, comprising a power plug, a control box, a charging plug and power cables connecting them, and further comprising:
a temperature sensor for detecting the temperature of the power plug and generating a temperature signal; and
a temperature signal feedback component which receives the temperature signal and generates a corresponding feedback signal according to the temperature signal;
wherein the temperature signal feedback component is coupled to an on-board control unit of the electric vehicle that is being charged, and the feedback signal is transmitted to the on-board control unit.

In the charging device according to an embodiment of the invention, the temperature signal feedback component is disposed in the control box, or is implemented by means of the control box.

In the charging device according to an embodiment of the invention, when the temperature is higher than or equal to a preset temperature value, the temperature signal feedback component generates a feedback signal that indicates overheat of the power plug.

In the charging device according to an embodiment of the invention, the feedback signal is a PWM signal having a duty cycle of D, wherein 90%<D≤97%.

In the charging device according to an embodiment of the invention, the temperature sensor is disposed in the power plug or in a power cable near the power plug.

According to another aspect of the invention, a charging system for electric vehicle is provided, comprising:
a charging device according to any of the above described;
an on-board control unit disposed in the electric vehicle;
a remote communication control module disposed in the electric vehicle; and
a mobile terminal that can be in wireless communicative connection with the remote communication control module;
wherein the on-board control unit is configured to read the feedback signal and send corresponding notification information of overheat in charging to the remote communication control module when the temperature is higher than or equal to a preset temperature value; the mobile terminal acquires the notification information of overheat in charging via the remote communication control module.

In the charging system according to an embodiment of the invention, the on-board control unit is further configured to control the magnitude of charging current based on the feedback signal.

In the charging system according to an embodiment of the invention, a backstage system is further included, which is used for realizing the wireless communicative connection between the mobile terminal and the remote communication control module.

In the charging system according to an embodiment of the invention, the on-board control unit is an entire vehicle control unit or an on-board charging module, or a combination of entire vehicle control unit and on-board charging module.

In the charging system according to an embodiment of the invention, the electric vehicle is an electric vehicle that can realize the function of vehicle networking.

According to further another aspect of the invention, a charging method for electric vehicle is provided, comprising the steps of:
detecting the temperature of a power plug of a charging device and generating a temperature signal;
generating a corresponding feedback signal according to the temperature signal;
transmitting the feedback signal to an on-board control unit;
reading the feedback signal by the on-board control unit and sending corresponding notification information of overheat in charging to a remote communication control module when the temperature is higher than or equal to a preset temperature value; and
transmitting the notification information of overheat in charging to a corresponding mobile terminal by the remote communication control module.

In the charging method according to an embodiment of the invention, the following step is further included: the on-board control unit controls the magnitude of charging current based on the feedback signal.

In the charging method according to an embodiment of the invention, in the step of controlling the magnitude of charging current, the charging current is firstly controlled to be reduced to a certain value, and if the temperature is still higher than or equal to the preset temperature value or is increased to be higher than or equal to a certain specified threshold value, the charging current is controlled to be reduced to zero.

The invention can monitor an overheat condition of the charging device and timely notify the corresponding mobile terminal, which is advantageous for timely eliminating the hidden safety hazard in the charging process and ensuring the safety of the charging process; moreover, an overall implementation of charging system is simple and has a low cost.

### BRIEF DESCRIPTION OF THE DRAWINGS

The above and other objects and advantages of the invention will become more complete and clear from the flowing detailed description in connection with accompanying drawings, wherein identical or similar elements are denoted by identical reference signs.

FIG. 1 is a schematic view showing the structure of a charging device for electric vehicle according to an embodiment of the invention;

FIG. 2 is a schematic view showing an internal structure of a power plug of the charging device shown in FIG. 1;

FIG. 3 is a schematic perspective view showing the structure of the power plug of the charging device shown in FIG. 1 after an insulation clad layer is partially removed;

FIG. 4 is a schematic view showing the structure of a charging system for electric vehicle according to an embodiment of the invention; and

FIG. 5 is a schematic flowchart showing a charging method for electric vehicle according to an embodiment of the invention.

### DETAILED DESCRIPTION OF THE INVENTION

The invention will be now described more fully with reference to the accompanying drawings, in which illustrative embodiments of the invention are shown. However, the invention can be carried out in many different ways, and should not be considered as being limited to the embodiments set forth herein. Instead, these embodiments are provided so as to enable the disclosure to become thorough and complete, and to completely convey the concept of the invention to those skilled in the art. In the drawings, identical elements or components are denoted by identical reference signs, and therefore a repeated description thereof will be omitted.

Herein, the electric vehicle refers to a vehicle that is driven at least partially by electric power of on-board battery, and the on-board battery is required to be charged by an external power supply for a plurality of times. The electric vehicle mainly comprises a battery-driven electric vehicle and a hybrid electric vehicle.

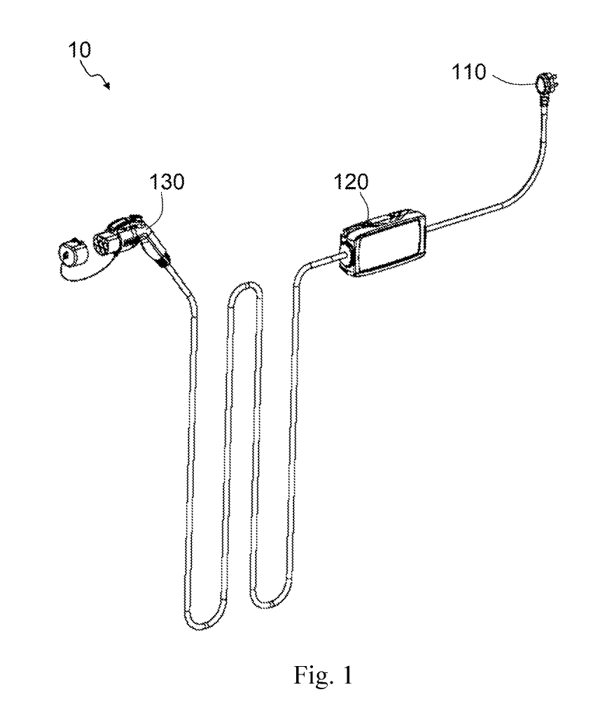

FIG. 1 is a schematic view showing the structure of a charging device for electric vehicle according to an embodiment of the invention. As shown in FIG. 1, the charging device 10 is for example a charging gun, which mainly comprises a power plug 110, a charging box 120 and a charging plug 130, wherein the power plug 110 can be connected to a power interface (e.g., socket) of AC grid, the charging box 120 can have functions such as monitoring the charging process, and the charging plug 130 can be insertedly connected to a charging interface of the electric vehicle so as to charge the on-board battery (e.g., power battery).

In addition, the power plug 110, the charging box 120 and the charging plug 130 are connected in sequence via power cables. In the invention, signal wires can be disposed inside the power cables for transmitting corresponding signals.

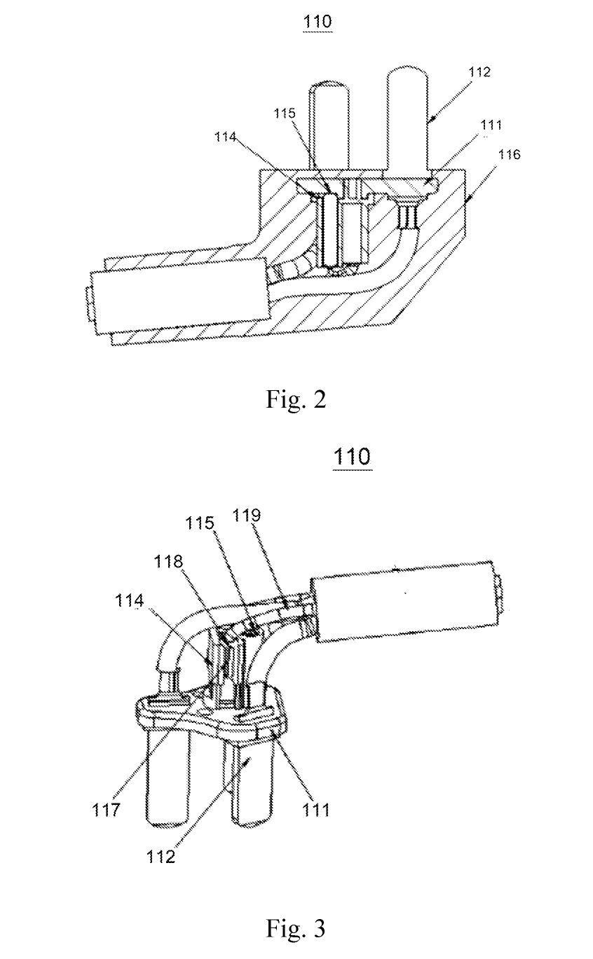

FIG. 2 is a schematic view showing an internal structure of the power plug of the charging device shown in FIG. 1, and FIG. 3 is a schematic perspective view showing the structure of the power plug of the charging device shown in FIG. 1 after an insulation clad layer is partially removed. With reference to FIGS. 2 and 3, the power plug 110 of an embodiment for example has three exposed pins 112 used for being electrically connected to the power interface. The shape and/or number of the pins 112 can be set according to the form of the power interface. All the internal components of the power plug 110 are substantially covered by an insulation clad layer 116 so that an electrical isolation from the outside is well realized.

With continued reference to FIGS. 2 and 3, the power plug 110 has a base 111, and an end of each pin 112 is fixed on the base 111 and is connected to a power line of the power cables. In an embodiment, a temperature sensor 115 is fixedly disposed on the base 111 and can detect the temperature of the power plug 110 in real time. The temperature sensor 115 can generate a temperature signal that indicates the magnitude of temperature; specifically, the temperature sensor 115 can be for example formed by a circuit provided with a temperature sensitive resistor. The specific type of the temperature sensor 115 is not limiting.

Specifically, the temperature signal generated by the temperature sensor 115 can be transmitted to the control box 120 via a signal wire 119 disposed in the power cables. An end of the signal wire 119 can be connected to the temperature sensor 115 via a connecting terminal 118, and the other end of the signal wire 119 can be connected to a temperature signal feedback component (not shown) in the control box 120.

In order to protect the temperature sensor 115, a protective lid 114 can be disposed for the temperature sensor 115 in the power plug 110, and a heat shrink tube 7 can be also disposed, etc.

In the embodiment shown above in FIGS. 2 and 3, by providing the temperature sensor 115 inside the power plug 110, the temperature of the temperature sensor 115 can be detected in real time during the charging process and a corresponding temperature signal can be generated. Therefore, the temperature signal of the power plug 110 in an overheat condition can be acquired by the temperature signal feedback component.

In another alternative embodiment, the temperature sensor 115 can be also disposed in the power cable near the power plug 110, and the temperature detected by the temperature sensor 115 can also substantially reflect the current temperature or overheat condition of the power plug 110.

It is noted that the above overheat condition can be caused by the following cause without limitation thereto:
when the power plug 110 of the charging device 10 is connected to (in electrical contact with) the socket of AC grid, loosening of the fit between the power plug and the socket may be easy to occur due to a long time charging, or the electrical contact between the power plug 110 and the socket may be weakened since the power cable near the power plug 110 is in a bending state for a long time, thus easily resulting in overheat.

With continued reference to FIG. 1, in an embodiment, a temperature signal feedback component is disposed in the control box 120. The temperature signal feedback component is connected to the signal wire 119, receives the temperature signal from the temperature sensor 115 and generates a corresponding feedback signal according to the temperature signal. Specifically, the feedback signal includes but is not limited to CP (clock pulse) signal. For example, more specifically, the feedback signal uses a PWM signal having a duty cycle of D, wherein 90%<D≤97%, thus meeting corresponding international standard. The feedback signal is defined by using a reserved duty cycle space of the PWM signal of the communication between the control box 120 and the electric vehicle. Therefore, not only a compatibility with existing charging gun device is easily realized, but also the transmission and subsequent reading of the feedback signal becomes more convenient. An overall compatibility with existing charging control mechanism is easy to realize.

In a specific embodiment, the temperature signal feedback component can generate a feedback signal having a certain duty cycle (which is at a value larger than 90% and smaller than or equal to 97%) only when the temperature is higher than or equal to the preset temperature value. The preset temperature value can be set in advance; if the temperature is higher than or equal to the preset temperature value, it means that the power plug is overheated, and there may be a hidden safety hazard.

It should be understood that the temperature signal feedback component is disposed in the control box 120, or can be also implemented via a certain signal generation component of the control box.

It should be noted that a corresponding signal wire is also disposed in the power cables between the charging plug 130 and the control box 120 for at least transmitting the feedback signal, for example. Of course, it can be also used for transmitting other signals of the on-board control unit; the charging plug 130 not only transmits electric power to the battery of the electric vehicle via the charging interface of the electric vehicle, but also simultaneously performs information interaction or transmission with the charging interface. When the charging plug 130 can be insertedly connected to the charging interface of the electric vehicle, the control box 120 (comprising the temperature signal feedback component disposed therein) is in handshake connection with the on-board control unit (e.g., vehicle control unit (VCU), on-board charging module (OBCM, or referred to as on-board charging generator), etc.) at one end of the electric vehicle so as to at least transmit the above feedback signal indicating the temperature.

The charging device 10 in the above embodiment can detect the temperature of the power plug and realize feedback of the temperature signal to an end of the vehicle in a simply way, and has a low cost of implementation. Moreover, a retrofit on the existing charging gun is realized easily.

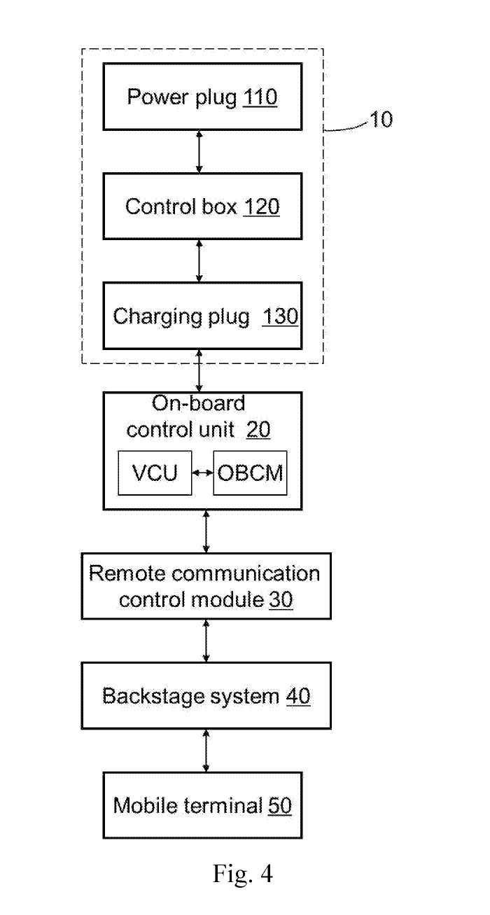

FIG. 4 is a schematic view showing the structure of a charging system for electric vehicle according to an embodiment of the invention. As shown in FIG. 4, the charging system of the embodiment of the invention uses the charging device 10 as shown in FIG. 1 and further mainly comprises an on-board control unit 20 disposed at one end of the electric vehicle and a remote communication control module 30.

The electric vehicle is typically provided with VCU and OBCM. In the present embodiment, the electric vehicle is an electric vehicle that can realize the function of vehicle networking. Therefore, the electric vehicle is further provided with a corresponding vehicle network control unit (e.g., on-board T-Box), and the VCU, OBCM and on-board T-Box are coupled to each other via CAN buses. In an embodiment, both the on-board control unit 20 and the remote communication control module 30 can be realized via existing hardware modules of the electric vehicle having the vehicle networking function. For example, the remote communication control module 30 is on-board T-Box, and the on-board control unit 20 is VCU and/or OBCM, thus greatly reducing the cost of hardware. The on-board control unit 20 and the on-board T-Box can be specifically connected via CAN buses, and various information can be transmitted between them.

In an embodiment, the following function can be realized by installing a corresponding program in the on-board control unit 20: reading the feedback signal sent from the temperature signal feedback component and sending corresponding notification information of overheat in charging to the remote communication control module 30 when the temperature is higher than or equal to a preset temperature value. When the feedback signal is PWM signal, the on-board control unit 20 can realize the reading operation by reading the duty cycle D of the feedback signal.

Specifically, as shown in FIG. 4, the on-board control unit 20 is realized by VCU and OBCM, and the temperature signal feedback component can be disposed in the control box 120. OBCM can be connected to the control box 120 of the charging device 10 via the signal wire, and can further transmit the feedback signal sent from the control box 120 to VCU via CAN bus. VCU can read the feedback signal so as to read the temperature signal of the power plug, and generate and send corresponding notification information of overheat in charging (e.g., to the on-board T-Box) when the temperature is higher than or equal to a preset temperature value.

In an embodiment, when information interaction is conducted between VCU and OBCM via CAN signal, VCU reads the signal by reading the duty cycle of the PWM signal (e.g., realizing reading the feedback signal in a form of PWM having a duty cycle at a certain value). Specifically, information interaction can be conducted in the way shown in table 1 below, thus realizing control over the charging current by OBCM.

TABLE 1
mapping relationship of duty cycle D of PWM signal
and limit value of charging current

| Duty cycle D of PWM | Maximum charging current Iₘₐₓ/A |
|---|---|
| D <3% | Charging not allowed |
| 3% ≤ D ≤ 7% | Duty cycle of 5% represents need for digital |
| | communication that is required to be established |
| | between charging pole and electric vehicle before |
| | charging, and charging is not allowed when there |
| | is no digital communication |
| 7% < D < 8% | Charging not allowed |
| 8% ≤ D < 10% | Iₘₐₓ = 6 |
| 10% ≤ D ≤ 85% | Iₘₐₓ = (D × 100) × 0.6 |
| 85% < D ≤ 90% | Iₘₐₓ = (D × 100 − 64) × 2.5 and Iₘₐₓ ≤ 63 |
| 90% < D ≤ 97% | Reserved |
| D >97% | Charging not allowed |

It is noted that the above reserved range 90%≤D97% of duty cycle can be used to represent the feedback signal generated by the charging device 10 so that it can be also read by VCU or OBCM.

In an embodiment, in order to prevent the charging current which is overly high after overheat from causing hidden safety hazard, the on-board control unit 20 is further configured to control the magnitude of charging current based on the feedback signal that was read. For example, VCU sends an instruction (e.g., represented in the form of PWM signal shown in table 1) for controlling the magnitude of charging current to OBCM based on the magnitude of the temperature that was read. The specific degree to which the magnitude of charging current is controlled to reduce can be set according to the specific application. For example, the charging current is reduced to be smaller than or equal to 0.1 A; in another embodiment, if the temperature of the feedback signal read by VCU is still higher than or equal to the preset temperature value or is even raised to be higher than or equal to a certain specified threshold value (e.g., 10 degree celsius higher than the preset temperature value) after VCU sends the above instruction of controlling the magnitude of charging current to reduce, VCU can send an instruction (e.g., a PWM signal having a duty cycle D larger than 97% or smaller than 3%) for controlling the magnitude of charging current that does not allow charging to OBCM, thus interrupting the charging process. In this way, dangerous accidents such as burning of the charging device 10 or the like can be avoided.

It should be understood that in further another alternative embodiment, the on-board control unit 20 can be realized via OBCM only. The functions of VCU in the above embodiment of for example reading the feedback signal, generating and sending corresponding notification information of overheat in charging can be also realized by programming on OBCM. In still further another alternative embodiment, the on-board control unit 20 can be also realized via VCU only. In this situation, the function of sending an instruction for controlling the magnitude of charging current based on the feedback signal that was read is realized by OBCM outside of the on-board control unit 20.

With continued reference to FIG. 4, the charging system further comprises a mobile terminal 50 which is in wireless communicative connection with the remote communication control module 30. In an embodiment, the communicative connection (e.g., 4G communicative connection) between the mobile terminal 50 and the on-board remote communication control module 30 is realized by a backstage system 40. The backstage system 40 can be the backstage system in the vehicle networking system, e.g., TSP backstage. The mobile terminal 50 can be specifically a mobile terminal 50 of user who needs to know the overheat condition of the power plug 110 of the charging device 10, e.g., the mobile terminal 50 carried by the user of electric vehicle. Specifically, the mobile terminal 50 can be a smart phone, on which a corresponding App is installed so as to receive the notification information of overheat in charging transmitted from the on-board remote communication control module 30, which can be displayed on the mobile terminal 50, or a reminding or alarming signal or the like can be also sent. As such, the user can know the overheat condition of the charging device 10 at any time, and an on-site inspection can be conducted so as to eliminate hidden safety hazard.

The charging system in the above embodiments enables the user of the mobile terminal 50 to know the overheat condition of the charging device 10 timely, and this is realized via VCU and the remote communication control module 30 on the vehicle side, without need for upgrading or retrofitting bulky hardware such as the control box of the charging device. The overall implementation is easy and the cost is low; in addition, by using PWM signal having a reserved duty cycle to represent the feedback signal and conducting information interaction between the on-board control unit 20 and the control box 120, a compatibility with existing standard at electric vehicle side becomes easy; moreover, reading of the feedback signal by the on-board control unit 20 is easy to realize, and the magnitude of charging current can be controlled based on the feedback signal that was read.

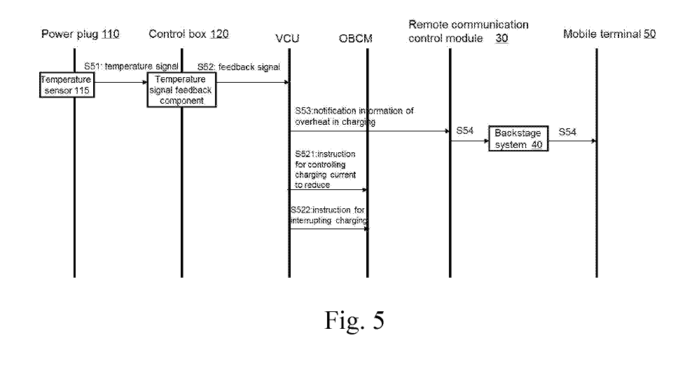

FIG. 5 is a schematic flowchart showing a charging method for electric vehicle according to an embodiment of the invention. With reference to FIGS. 4 and 5, the charging method mainly comprises the following steps:
firstly, at step S51, in the charging process, detecting the temperature of the power plug 110 of the charging device 10 and generating a temperature signal, which is generated by a temperature sensor 115 and transmitted to a temperature signal feedback component;
at step S52, receiving the temperature signal and generating a corresponding feedback signal according to the temperature signal, and sending the feedback signal to an on-board control unit 20; specifically, when the temperature is higher than or equal to a preset temperature value, a corresponding feedback signal is generated according to the temperature signal, e.g., a PWM signal having a duty cycle D that is at a certain value in a range larger than 90% and smaller than or equal to 97% is generated;
at step S53, reading the feedback signal by VCU and sending corresponding notification information of overheat in charging to a remote communication control module 30 when the temperature is higher than or equal to a preset temperature value; the notification information of overheat in charging can be transmitted via CAN bus;
at step S54, sending the notification information of overheat in charging to a corresponding mobile terminal 50 by the remote communication control module 30. In an embodiment, the notification information of overheat in charging is forwarded by a backstage system 40 of vehicle network in the form of 4G signal. In this way, the mobile terminal 50 can know overheat faulty condition of charging timely.

In an embodiment, step S521 is further included, in which VCU sends an instruction of controlling the charging current to reduce to OBCM, based on the feedback signal that was read. For example, if the PWM signal is sent to the charging device 10 in the way shown in table 1 so as to control the magnitude of charging current, the charging current can be controlled to reduce to a certain preset value (e.g., 0.1 A) when there is overheat. In another embodiment, step S522 is further included. If the temperature of the feedback signal read by VCU is still higher than or equal to the preset temperature value or is even raised to be higher than or equal to a certain specified threshold value (e.g., 10° C. higher than the preset temperature value) after step S521, VCU can send an instruction (e.g., a PWM signal having a duty cycle D larger than 97% or smaller than 3%) for controlling the magnitude of charging current that does not allow charging to OBCM, thus interrupting the charging process.

It will be understood that when a component is referred to as being “connected” or “coupled” to another component, the component can be connected or coupled to said another component directly, or there can be an intervening component.

Some block diagrams (e.g., VCU, remote communication control module) shown in the drawings are functional entities, which do not necessarily correspond to entities that are independent physically or logically. These functional entities can be realized in the form of software, or realized in one or more hardware modules or integrated circuits, or in different networks and/or processor devices and/or micro-controller devices.

The above examples mainly illustrate the charging device, charging system and charging method for electric vehicle of the invention. While only some embodiments of the invention have been described, those skilled in the art will understand that the invention can be carried out in many other different ways without departing from the spirit and scope thereof. Therefore, the illustrated examples and embodiments should be considered as schematic rather than limiting. The invention can cover various modifications and replacements without departing from the spirit and scope of the invention as defined by individual appended claims.

What is claimed is:

1. A charging device for electric vehicle, comprising a power plug, a control box, a charging plug and power cables connecting them, characterized by further comprising:
a temperature sensor for detecting the temperature of the power plug and generating a temperature signal; and
a temperature signal feedback component which receives the temperature signal and generates a corresponding feedback signal according to the temperature signal;
wherein the temperature signal feedback component is coupled to an on-board control unit of the electric vehicle that is being charged, and the feedback signal is transmitted to the on-board control unit.

2. The charging device according to claim 1, wherein the temperature signal feedback component is disposed in the control box, or is implemented by means of the control box.

3. The charging device according to claim 1, wherein when the temperature is higher than or equal to a preset temperature value, the temperature signal feedback component generates a feedback signal that indicates overheat of the power plug.

4. The charging device according to claim 1, wherein the feedback signal is a PWM signal having a duty cycle of D, wherein 90%<D≤97%.

5. The charging device according to claim 1, wherein the temperature sensor is disposed in the power plug or in a power cable near the power plug.

6. A charging system for electric vehicle, characterized by comprising:
a charging device according to claim 1;
an on-board control unit disposed in the electric vehicle;
a remote communication control module disposed in the electric vehicle; and
a mobile terminal that can be in wireless communicative connection with the remote communication control module;
wherein the on-board control unit is configured to read the feedback signal and send corresponding notification information of overheat in charging to the remote communication control module when the temperature is higher than or equal to a preset temperature value; the mobile terminal acquires the notification information of overheat in charging via the remote communication control module.

7. The charging system according to claim 6, wherein the on-board control unit is an entire vehicle control unit or an on-board charging module, or a combination of entire vehicle control unit and on-board charging module.

8. The charging system according to claim 7, wherein the on-board control unit is further configured to control the magnitude of charging current based on the feedback signal.

9. The charging system according to claim 6, wherein further comprising a backstage system, which is used for realizing the wireless communicative connection between the mobile terminal and the remote communication control module.

10. A charging method for electric vehicle, characterized by comprising the steps of:
detecting the temperature of a power plug of a charging device and generating a temperature signal;
generating a corresponding feedback signal according to the temperature signal;
transmitting the feedback signal to an on-board control unit;
reading the feedback signal by the on-board control unit and sending corresponding notification information of overheat in charging to a remote communication control module when the temperature is higher than or equal to a preset temperature value; and
transmitting the notification information of overheat in charging to a corresponding mobile terminal by the remote communication control module.

11. The charging method according to claim 10, wherein further comprising a step of the on-board control unit controlling the magnitude of charging current based on the feedback signal.

12. The charging method according to claim 11, wherein, in the step of controlling the magnitude of charging current, the charging current is firstly controlled to be reduced to a certain value, and if the temperature is still higher than or equal to the preset temperature value or is increased to be higher than or equal to a certain specified threshold value, the charging current is controlled to be reduced to zero.

13. The charging device according to claim 3, wherein the feedback signal is a PWM signal having a duty cycle of D, wherein 90%<D≤97%.

14. A charging system for electric vehicle, comprising a charging device according to claim 2 and further comprising:
an on-board control unit disposed in the electric vehicle;
a remote communication control module disposed in the electric vehicle; and
a mobile terminal that can be in wireless communicative connection with the remote communication control module;
wherein the on-board control unit is configured to read the feedback signal and send corresponding notification information of overheat in charging to the remote communication control module when the temperature is higher than or equal to a preset temperature value; the mobile terminal acquires the notification information of overheat in charging via the remote communication control module.

15. A charging system for electric vehicle, comprising a charging device according to claim 3 and further comprising:
an on-board control unit disposed in the electric vehicle;
a remote communication control module disposed in the electric vehicle; and
a mobile terminal that can be in wireless communicative connection with the remote communication control module;
wherein the on-board control unit is configured to read the feedback signal and send corresponding notification information of overheat in charging to the remote communication control module when the temperature is higher than or equal to a preset temperature value; the mobile terminal acquires the notification information of overheat in charging via the remote communication control module.

16. A charging system for electric vehicle, comprising a charging device according to claim 4 and further comprising:
an on-board control unit disposed in the electric vehicle;
a remote communication control module disposed in the electric vehicle; and
a mobile terminal that can be in wireless communicative connection with the remote communication control module;
wherein the on-board control unit is configured to read the feedback signal and send corresponding notification information of overheat in charging to the remote communication control module when the temperature is higher than or equal to a preset temperature value; the mobile terminal acquires the notification information of overheat in charging via the remote communication control module.

17. A charging system for electric vehicle, comprising a charging device according to claim 5 and further comprising:
an on-board control unit disposed in the electric vehicle;
a remote communication control module disposed in the electric vehicle; and
a mobile terminal that can be in wireless communicative connection with the remote communication control module;
wherein the on-board control unit is configured to read the feedback signal and send corresponding notification information of overheat in charging to the remote communication control module when the temperature is higher than or equal to a preset temperature value; the mobile terminal acquires the notification information of overheat in charging via the remote communication control module.
